(19) United States
(12) Patent Application Publication
(10) Pub. No.: US 2026/0211960 A1
(43) Pub. Date: Jul. 23, 2026

(54) SYSTEMS AND METHODS FOR GENERATING ARTIFICIAL INTELLIGENCE GENERATED CONTENT

(71) Applicant: The Toronto-Dominion Bank, Toronto (CA)

(72) Inventors: Vipul Kishore LALKA, Oakville (CA); Venkatanarayanan MAHALINGAM, Kitchener (CA); Shivani OBEROI, Toronto (CA); Ayda YORUKOGLU, Toronto (CA); Arnav Kumar MUNSHI, Toronto (CA)

(73) Assignee: The Toronto-Dominion Bank, Toronto (CA)

(21) Appl. No.: 19/032,191

(22) Filed: Jan. 20, 2025

(51) Int. Cl. G06F 16/9536; G06F 16/735; G06F 16/9538

(52) U.S. Cl. CPC G06F 16/9536; G06F 16/735; G06F 16/9538

(57) ABSTRACT

Systems and methods are described for generating content for account data based on social media preferences. A computing system retrieves social media data via a network from a social media account associated with an account holder. The account holder holding an account separate from the social media account. The computing system determines at least one social media preference based on the social media data; obtain account data associated with the account; and generates a video summarizing at least a portion of the account data based on the at least one social media preference.

### TECHNICAL FIELD

The present disclosure relates to artificial intelligence generated content and, in particular, to systems and methods for generating content for database record data based on saved preferences.

### BACKGROUND

AI content generation involves using artificial intelligence algorithms to create various forms of content, such as text, images, audio, and video. These algorithms analyze vast amounts of data to understand patterns and structures in human language and other media. By leveraging this understanding, AI can generate new content that mimics human creativity and style. This technology is used in a wide range of applications, from writing articles and creating marketing materials to generating artwork and composing music.

### BRIEF DESCRIPTION OF THE DRAWINGS

Reference will now be made, by way of example, to the accompanying drawings which show example embodiments of the present application and in which:

FIG. 1 is a schematic operation diagram illustrating an operating environment;

FIG. 2 is a high-level schematic diagram of a computing system;

FIG. 3 shows a simplified organization of software components stored in memory of the computing system of FIG. 2;

FIG. 4 shows a high-level schematic diagram on an example parallel processing architecture;

FIG. 5 shows, in flowchart form, a method of generating AI generated content based on account data and social media preferences;

FIG. 6 is a block diagram of an example AI content generator;

FIGS. 7A to 7B show example pages of a graphical user interface for displaying AI generated content; and

FIG. 8 shows a high-level schematic diagram of a development platform for training the AI content generator.

Like reference numerals are used in the drawings to denote like elements and features.

### DETAILED DESCRIPTION

According to an aspect, there is provided a computing system having a communications module communicable with a network; a memory; and a processor coupled to the communications module and the memory. The processor may be configured to: retrieve social media data via the network from at least one social media account associated with an account holder, the account holder holding an account separate from the at least one social media account; determine at least one social media preference based on the social media data; obtain account data associated with the account; generate a video summarizing at least a portion of the account data based on the at least one social media preference; and provide the video on an account holder device. The processor may be configured to: identify the at least one social media account by searching an identifier of the account holder in a search engine of at least one social media platform; identify the at least one social media account associated with the account holder by linking a first social media account associated with the account holder to an account manager; and/or retrieve the social media data related to a plurality of the at least one social media account that are linked to the first social media account associated with the account holder; and determine the at least one social media preference from the plurality of the at least one social media account. The at least one social media preference comprises a plurality of categories for the plurality of the at least one social media account. The generating the video may further comprise: processing a subset of the account data and the at least one social media preference into an artificial intelligence content generator. The social media data comprises metadata associated with at least one followed account. The processor may be configured to: categorize the at least one followed account into at least one category. The at least one social media preference may be determined periodically. The account data may comprise at least one transfer to or from the account.

According to another aspect, there is provided a computer-implemented method comprising: retrieving social media data via a network from at least one social media account associated with an account holder, the account holder holding an account separate from the at least one social media account; determining at least one social media preference based on the social media data; obtaining account data associated with the account; generating a video summarizing at least a portion of the account data based on the at least one social media preference; and providing the video on an account holder device. The method may further comprise identifying the at least one social media account associated with the account holder by searching an identifier of the account holder in a search engine of at least one social media platform; identifying the at least one social media account associated with the account holder by linking a first social media account associated with the account holder to an account manager; and/or retrieving the social media data related to a plurality of the at least one social media account that are linked to the first social media account associated with the account holder; and determining the at least one social media preference from the plurality of the at least one social media account.

The at least one social media preference may comprise a plurality of categories for the plurality of the at least one social media account. The generating the video may further comprise processing a subset of the account data and the at least one social media preference into an artificial intelligence content generator. The social media data may comprise metadata associated with at least one followed account. The method may further comprise categorizing the at least one followed account into at least one category. The at least one social media preference may be determined periodically. The account data may comprise at least one transfer to or from the account.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all the elements, and may include additional elements.

In the present application, the phrase “at least one of . . . or . . . ” is intended to cover any one or more of the listed elements, including any one of the listed elements alone, any sub-combination, or all the elements, and may include additional elements, and may not require all the elements.

Presentation of transaction histories may be presented in a text-based, chart-based, and/or graph-based format. For example, library systems may provide an accounting of borrowing and returning books, DVDs, etc. In another example, gaming platforms may provide an accounting of transfers of currency to purchase licenses to games, transferring licenses to other accounts, storing progress, etc. In yet another example, an educational platform may enroll students in courses, track their progress, transfer credits between different courses and/or institutions. In even yet another example, in a banking system, customers may transfer funds between accounts, invest, etc.

The transaction histories presented in a text-based, chart-based, and/or graph-based format may be in a format that does not engage the account holder and/or explain the information in a preferred format. The present application discloses an artificial intelligence (AI) content generating platform that may present transaction histories in a more dynamic form by engaging one or more social media preferences. As described herein, the transaction histories may be transformed by one or more AI content generators to provide the transaction histories in a format that may provide more meaning to the customer. In particular, the AI content generator may transform the account data based on one or more social media preferences retrieved from a social media account of the same person. For example, the AI content generator may provide one or more videos resembling the TikTok format and/or may tailor the videos to particular interests of the customer.

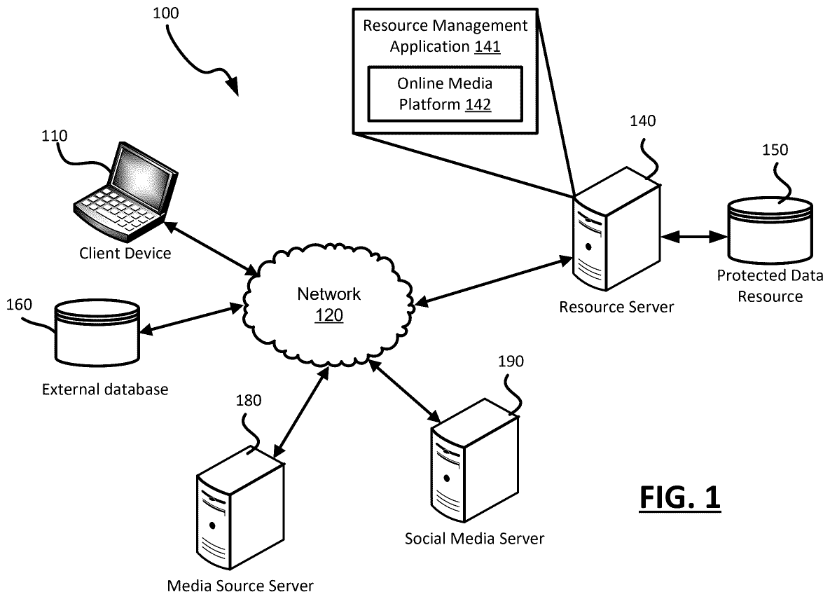

FIG. 1 is a schematic diagram of an operating environment in accordance with embodiments of the present disclosure. FIG. 1 illustrates components of a system 100, including one or more account holder devices 110, a resource server 140, a protected data resource 150, at least one media source server 180, and a social media platform comprising one or more social media servers 190. The components of system 100 may be configured to provide, in conjunction, various functionalities associated with an online media platform. More particularly, the system 100 may provide an online video platform (or application, portal, etc.) containing video content that can be accessed using an account holder device 110. The video content may be selectively presented via the online platform such that users can access videos from the media source servers 180 that are relevant or of interest to them.

As illustrated, a resource server 140 and account holder device 110 communicate via the network 120. The account holder device 110 is a computing system 105 that may be associated with an entity, such as a user or client, having resources associated with the resource server 140 and/or the protected data resource 150. For example, the resource server 140 may track, manage, maintain, and/or lend resources to the entity. The resources may, for example, be computing resources, such as memory or processor cycles. By way of further example, the resources may comprise stored value, such as fiat currency, which may be represented in the protected data resource 150. Each of the entities may be associated with one or more secure logical storage locations stored within the protected data resource 150.

The resource server 140 may be coupled to the protected data resource 150, which may be provided in secure storage. The secure storage may be provided internally within the resource server 140 or externally. In some aspects, the secure storage may be provided remotely from the resource server 140. For example, the secure storage may include one or more data centers. The data centers may, for example, store data with bank-grade security.

The protected data resource 150 stores secure data. In particular, the protected data resource 150 may include one or more secure logical storage locations that may store records for accounts that are associated with various entities. That is, the secure data may comprise account data for one or more specific entities. For example, an entity that operates the account holder device 110 may be associated with an account having one or more records in the protected data resource 150. In at least some embodiments, the records may reflect a quantity of stored resources that are associated with an entity. Such resources may include owned resources and/or borrowed resources (e.g. resources available on credit). The quantity of resources that are available to or associated with an entity may be reflected by a balance defined in an associated record.

For example, the secure data in the protected data resource 150 may include financial data, such as banking data (e.g. bank balance, historical transactions data, etc.) and investment data (e.g. portfolio information) for an entity. In particular, the resource server 140 may be a financial institution (e.g. bank) server and the entity may be a customer of the financial institution which operates the financial institution server. The financial data may, in some embodiments, include processed or computed data such as, for example, an average balance associated with an account, an average spending amount associated with an account, a total spending amount over a period, or other data obtained by a processing server based on account data for the entity.

In some embodiments, the protected data resource 150 may be a computer system that includes one or more database servers, computer servers, and the like. In some embodiments, the protected data resource 150 may comprise an application programming interface (API) for a web-based system, operating system, database system, computer hardware, or software library.

As shown in FIG. 1, the resource server 140 may administer a resource management application 141. For example, the resource server 140 may be a back-end server associated with an application that allows users to manage various resources. In some aspects, the resource management application 141 may be a portfolio or account management software. The management software may enable users to, among others, conduct investment research, enter and execute trade orders, obtain market quotes, and manage one or more investment accounts. In particular, the portfolio management software can be used to manage holdings of tradeable objects, such as stocks, bonds, and commodities. In other aspects, the resource management application 141 may be a chequing, credit, and/or savings account platform for performing deposits, e-transfers, bill payments, loans, etc.

The resource management application 141 may be administered by a server that is different from the resource server 140. For example, an application server (not shown) that is independent of resource server 140 may provide back-end services associated with the resource management application 141.

The resource management application 141 may access user data that is stored in the protected data resource 150. For example, a user's financial data may be pulled from the protected data resource 150. The account holder's financial data may be consolidated (e.g. total amount of the user's investments and cash holdings) and the consolidated data may be provided to the account holder via the resource management application 141.

The resource management application 141 integrates an online media platform 142. Various media (e.g. videos, audio recordings, etc.) may be presented via the resource management application 141, and the online media platform 142 facilitates the presentation of the media. For example, the online media platform 142 may be configured to curate media content from multiple different media sources, such as from the media source server 180, and provide personalized selections of media to account holders of the resource management application 141. The content of the media may cover, for example, topics and subject matter which relate to the resources (e.g. holdings of tradeable objects) that account holder can manage using the resource management application 141. In aspects as described herein, the online media platform 142 may generate the media content of the videos, images, audio, etc. and/or the media content may be based on account data retrieved from the protected data resource 150.

The resource management application 141 may be accessible on the account holder device 110. For example, the resource management application 141 may be provided via a web interface that can be accessed using a web browser on the account holder device 110. Additionally, or alternatively, the resource management application 141 may be an application, different from a web browser, operating on the account holder device 110. For example, the resource management application 141 may be stored in memory of the account holder device 110 and executed thereon, such as a mobile app.

The system 100 includes at least one media source server 180. A media source server 180 may be associated with a third-party service which provides media content to one or more different computer systems. Specifically, a media source server 180 may transmit video content to one or more computing systems 105 which request the media content. A media source server 180 may host videos locally. Additionally, or alternatively, a media source server 180 may obtain media data (e.g. video data) from remote sources and transmit the media data to requesting computing devices.

The social media server 190 presented in FIG. 1 is a simplified representation of a social media system merely for convenience of reference. When implemented, the social media server 190 may comprise one or more of the following: frontend servers, backend servers, databases, caching systems, message queues, search engines, content delivery networks, microservices, load balancers, monitoring and analysis functions, and/or other functions. The social media server 190 may have one or more social media accounts with associated social media data stored in a repository. In this manner, the social media server 190 has a plurality of accessible repositories associated with a plurality of social media accounts. Social media content may be posted by the account holders using their account holder devices 110 and the social media content may be stored in the accessible repositories. The social media server 190 may retrieve the social media content and provide this content to other social media accounts.

The social media server 190 may enable the social media accounts to “follow” one or more other social media accounts thereby receiving at least some of the social media content from the followed accounts in a feed. The feed may be a continuous stream of social media content such that the account holder may scroll and/or flip through the feed to view the social media content from the other social media accounts on the account holder device 110. As the account holder scrolls, the social media server 190 transmits the feed from the social media server 190 to the account holder device 110. The feed may be periodically updated when the followed accounts post social media content. In some aspects, the social media server 190 may provide content from non-followed accounts that resemble social media content posted by the followed accounts.

The account holder may set one or more social media preferences using the account holder device 110 that may configure the feed, such as a frequency of social media content from followed accounts, a preference for video, images, audio, and/or text, etc. The account holder may set one or more security preferences that may limit their social media content to only specific types of social media accounts that are following the account holder's social media account. For example, one setting may limit images of the account holder to only be provided to “friends” account holder class. The account holder may adjust permissions for their respective social media account to permit access to the social media preferences by the resource server 140.

As illustrated in FIG. 1, a network 120 may connect the media source server 180, the account holder device 110, the resource server 140, and/or the social media server 190. The account holder device 110, the resource server 140, the media source server 180, and/or the social media server 190 may be in geographically disparate locations. Put differently, the account holder device 110 may be remote from one or all the resource server 140, the media source server 180, and/or the social media server 190.

The account holder device 110, the resource server 140, the media source server 180, and the social media server 190 are computer systems. The account holder device 110 may take a variety of forms including, for example, a mobile communication device such as a smartphone, a tablet computer, a wearable computer (e.g. head-mounted display, smartwatch, etc.), a laptop or desktop computer, or a computing device of another type.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

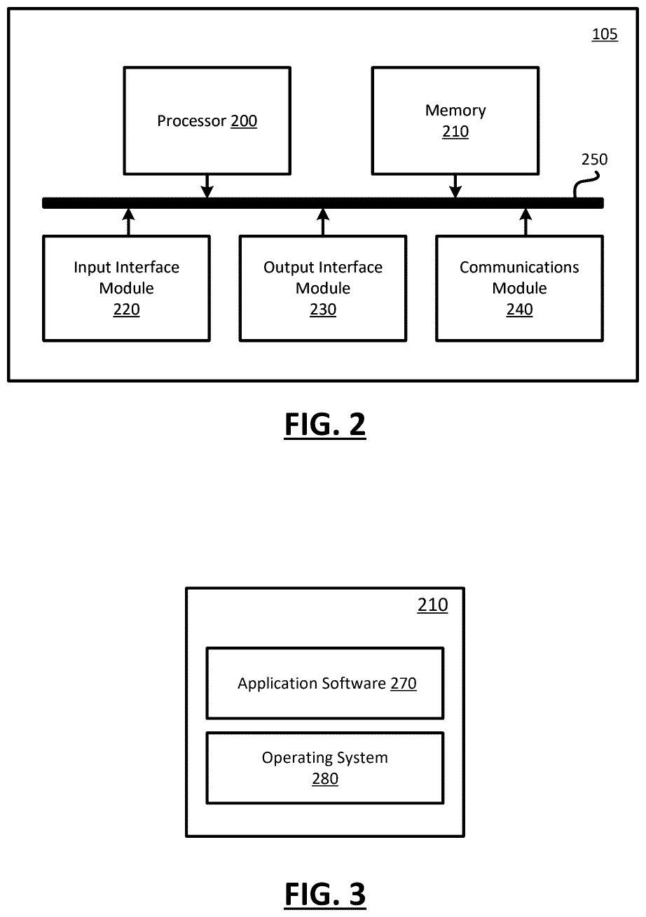

FIG. 2 is a high-level operation diagram of the computing system 105. In some aspects, the computing system 105 may be exemplary of one or more of the account holder devices 110, the resource server 140, the social media server 190, and/or the third-party media source server 180. The computing system 105 includes a variety of modules. For example, as illustrated, the computing system 105, may include a processor 200, a computer-readable memory 210, an input interface module 220, an output interface module 230, and a communications module 240. As illustrated, the foregoing example modules of the computing system 105 are in communication over a bus 250.

The processor 200 is a hardware processor. The processor 200 may, for example, be one or more ARM, Intel x86, PowerPC processors or the like.

The computer-readable memory 210 allows data and/or instructions to be stored and retrieved. The computer-readable memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the computing system 105.

The input interface module 220 allows the computing system 105 to receive input signals. Input signals may, for example, correspond to input received from a user. The input interface module 220 may serve to interconnect the computing system 105 with one or more input devices. Input signals may be received from input devices by the input interface module 220. Input devices may, for example, include one or more of a touchscreen input, keyboard, trackball, voice command interface, or the like. In some aspects, all or a portion of the input interface module 220 may be integrated with an input device. For example, the input interface module 220 may be integrated with one of the input devices.

The output interface module 230 allows the computing system 105 to provide output signals. Some output signals may, for example allow provision of output to a user. The output interface module 230 may serve to interconnect the computing system 105 with one or more output devices. Output signals may be sent to output devices by an output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some aspects, all or a portion of the output interface module 230 may be integrated with an output device. For example, the output interface module 230 may be integrated with one of the output devices.

The communications module 240 allows the computing system 105 to communicate with other electronic devices and/or various communications networks. For example, the communications module 240 may allow the computing system 105 to send or receive communications signals. Communications signals may be sent and/or received according to one or more protocols or according to one or more standards. For example, the communications module 240 may allow the computing system 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 240 may allow the computing system 105 to communicate using near-field communication (NFC), via Wi-Fi™, using Bluetooth™ or via some combination of one or more networks or protocols. In some aspects, all or a portion of the communications module 240 may be integrated into a component of the computing system 105. For example, the communications module 240 may be integrated into a communications chipset.

Software comprising instructions is executed by the processor 200 from a computer-readable medium. For example, software may be loaded into random-access memory from persistent storage of computer-readable memory 210. Additionally, or alternatively, instructions may be executed by the processor 200 directly from read-only memory of computer-readable memory 210.

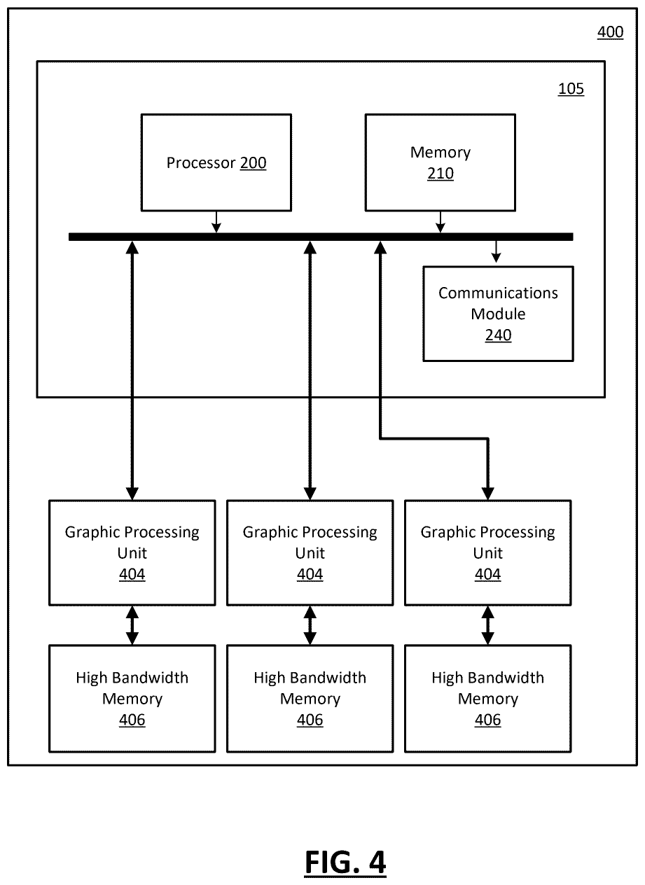

FIG. 3 depicts a simplified organization of software components stored in the computer-readable memory 210 of the computing system 105. As illustrated these software components include an operating system 280 and an application 270. The operating system 280 is software. The operating system 280 allows the application 270 to access the processor 200, the computer-readable memory 210, the input interface module 220, the output interface module 230 and/or the communications module 240. The operating system 280 may be, for example, Apple's iOS™, Google's Android™, Linux™, Microsoft's Windows™, or the like.

The application 270 adapts the computing system 105, in combination with the operating system 280, to operate as a device performing particular functions. For example, the application 270 may cooperate with the operating system 280 to adapt a suitable aspect of the computing system 105 to operate as the account holder device 110, the resource server 140, the application evaluation server 170, the social media server 190, and/or the media source server(s) 180.

While a single application 270 is illustrated in FIG. 3, in operation, the computer-readable memory 210 may include more than one application 270, and different applications 270 may perform different operations. For example, in aspects where the computing system 105 is functioning as an account holder device 110, the application 270 may comprise a value transfer application which may, for example, be a personal banking application. The value transfer application may be configured for secure communications with the resource server 140 and may provide various banking functions such as, for example, display of account balances, transfers of value (e.g. bill payments, money transfers), and other account management functions. In another example, the application 270 may be a content generation application executing on the resource server and/or the media source server 180.

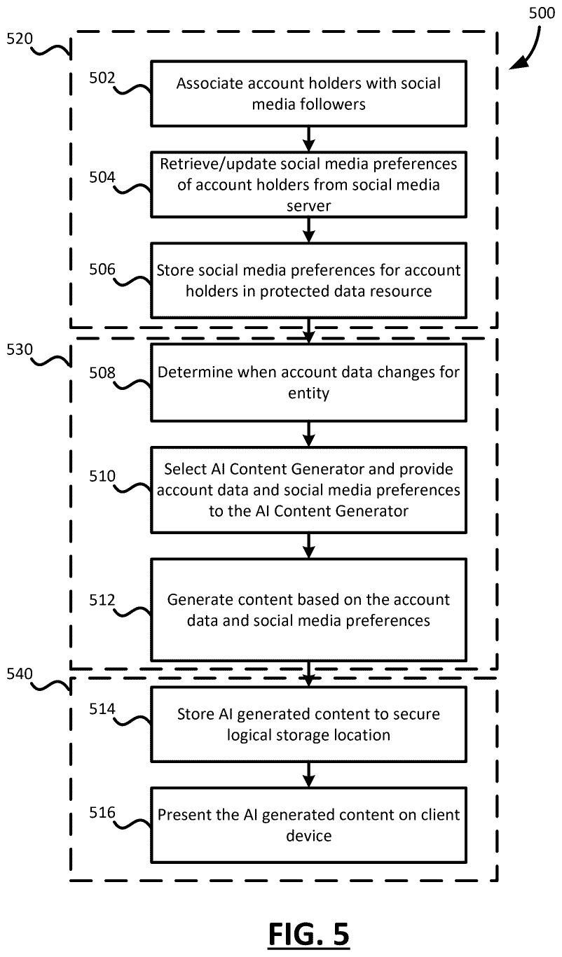

Turning to FIG. 4, the resource server 140 may execute one or more artificial intelligence (AI) content generators 910. In this aspect, the AI content generators 910 may comprise one or more replicas of an AI model, such as a large language model (LLM), a Generative Adversarial Networks (GANs), a Variational Autoencoder (VAE), a Recurrent Neural Network (RNN), a Transformer, a Diffusion Model, and/or any combination thereof executing in series, parallel, and/or recursively. For ease of reference, the replica is referred to as the AI content generator 910. One or more of these AI models may be selected based on the social media preferences associated with the account holder. For example, when the social media preferences specify realistic video, the processor 200 may select a GAN replica having a generator neural network and a discriminator evaluating the generators output to generate realistic video frames. The generator neural network may create new video frames from random noise or seed content as described in more detail herein. The generator neural network may be trained to generate realistic frames by analyzing patterns in the training data. The discriminator neural network may evaluate the frames produced by the generator neural network. The discriminator may try to distinguish between real frames from the training data and fake frames produced by the generator. The generator and discriminator may be trained together in a process called adversarial training. The generator creates video frames and sends them to the discriminator. The discriminator evaluates these frames and provides feedback on their realism. The generator uses this feedback to improve the video content with the goal of producing frames that are increasingly indistinguishable from real ones.

One or more AI content generators 910 may be executing on parallel processing hardware, such as a graphics processing unit (GPU) array 400. The GPU array 400 may comprise the computing system 105 as previously described. In some aspects, the computing system 105 may comprise the processor 200, the computer-readable memory 210, and the communications module 240. The processor 200 may execute one or more instructions from the computer-readable memory 210 to manage the GPU array 400. The GPU array 400 may comprise a plurality of GPUs 404 having associated high-bandwidth memory 406. The AI content generator 910 may be created when the processor 200 determines that account data has changed, is newly generated, and/or stored in the protected data resource 150. In some aspects, the protected data resource 150 may transmit a notification message to the processor 200 via the communications module 240 indicating the account data has changed.

The processor 200 may retrieve the social media preference data from the social media server 190 and select one or more corresponding AI content generators 910. The processor 200 may instruct the GPU array 400 to retrieve the AI content generator 910 from a model repository 410 and load the AI content generator 910 into the high-bandwidth memory 406 for execution by the GPU 404 prior to generating media content based on the account data and/or social media preferences. In some aspects, a previously executing AI content generator 910 that is no longer being used may be reset in preparation for the new interaction.

In an aspect, the GPU array 400 may be provided with the account data associated with the account holder to the AI content generator 910 as described in further detail below. The processor 200 may request content generation associated with the account data and/or the social media preferences from the AI content generator 910 executing on one or the GPUs 404.

The AI content generator 910 may receive the account data associated from the protected data resource 150 from one or more entities via their respective account holder devices 110 and in some aspects the account data may be routed by the processor 200 to the GPU 404 executing the AI content generator 910. In other aspects, the protected data resource 150 may communicate directly with the GPU 404 executing the AI content generator 910.

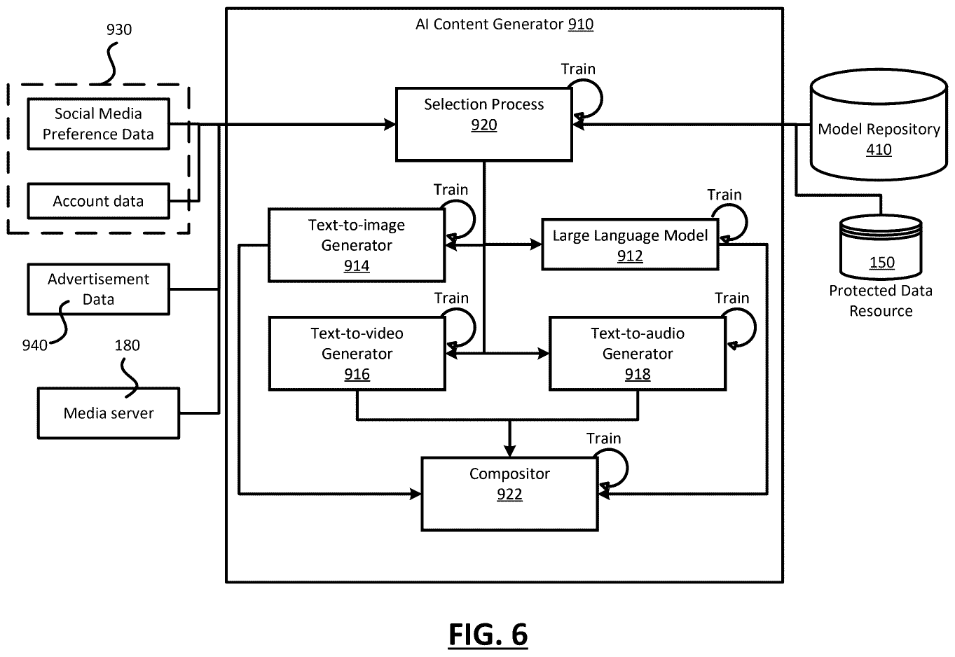

Turning to FIG. 5, a content generation and delivery process 500 may comprise an account manager process 520, a content generation process 530, and/or a content delivery process 540. The account manager process 520 involves, at step 502, associating an entity of the secure logical storage locations with a corresponding social media account of the social media server 190.

In an aspect, the resource server 140 may provide a prompting message to the account holder device 110 when the entity logs into their secure logical storage location. The prompting message may encourage the entity to “follow” or otherwise link to a provider social media account associated with the provider of the resource server 140. Some aspects may provide an incentive for the entity to link their social media account to their secure logical storage location. For example, the incentive may be a monetary reward, a digital code to a resource, a discount, etc. In some instances, the link directs the account holder device 110 to display a form where the entity may enter one or more social media identifiers, such as a social media username, for one or more social media accounts, such as Facebook™, Instagram™, X formerly known as Twitter™, TikTok™, YouTube™, LinkedIn™, Snapchat™, Twitch™, Pinterest™, Reddit™, WeChat™, etc. The form may contain terms and conditions for the entity to accept. The social media identifier may be stored in the secure logical storage location associated with the entity on the protected data resource 150.

In some instances, when the entity activates the “follow” prompt, such as clicking on a link displayed on the account holder device 110, a social media linking process executing on the account holder device 110 may determine an identifier for a follower social media account and provide the identifier to a social media monitoring process executing on the resource server 140. In some instances, the social media linking process may provide an event listener to the account holder device 110 when the entity logs into the resource server 140. The event listener may monitor for the entity activating the prompting message and when activated, the event listener may extract a social media account identifier associated with the entity and store the social media account identifier in the secure logical storage location associated with the entity on the protected data resource 150. In some instances, the social media linking process may determine the identifier based on a time that the follower social media account follows the provider social media account and correlating the time with the activation of the prompt by the account holder device 110. In some instances, the social media linking process may determine when an account identifier corresponds to a social media account identifier and/or may prompt for confirmation from the account holder device 110 to confirm the social media account identifier corresponds to the entity.

In some instances, the entity may use single sign-on (SSO) associated with the social media server 190 to log into the resource server 140. The SSO may be provided by Okta, OneLogin, Microsoft Entra ID, JumpCloud, Ping Identity, CyberArk, Auth0, OpenID Connect, etc. When the entity actives the SSO for the resource server 140 using the account holder device 110, the resource server 140 redirects the account holder device 110 to the social media server 190 and/or the authentication server to provide their credentials. When successfully authenticated, the social media server 190 and/or the authentication server generates a SSO token and sends the SSO token back to the resource server 140. The resource server 140 validates the SSO token and grants the entity access to the resource server 140. In some aspects, the authentication server and the social media server 190 may be the same server. Other aspects may have distinct authentication servers and social media servers. As part of the SSO process, the resource server 140 may be provided with profile data from the social media server 190 and/or the authentication server. The profile data may comprise the social media identifier, name, email address, profile picture, gender, age, age range, language, location, friends list, followers list, pages followed, etc. Some of or all the profile data may be stored in the secure logical storage location associated with the entity.

In some aspects, the social media linking process may perform a search with a search engine provided by the social media server 190. For example, the social media linking process may perform one or more searches using a client's name, a client's telephone number, a client's email address, and/or a client's identifier. The social media linking process may provide one or more of the matches to the account holder device 110 for linking to the secure logical storage location of the entity.

In some aspects, the social media linking process may identify other secure logical storage locations based on the friends list and/or the followers list. For example, when a social media identifier from the friends list and/or followers list matches an account identifier from one or more of the secure logical storage locations, the social media linking process may instruct a provider social media account to transmit a message to a social media account corresponding to the social media identifier. The message may request linking of the social media account with the account identifier associated with the secure logical storage location. The social media linking process may provide a similar linking message within the secure logical storage location for when the entity logs into the resource server 140 using their account holder device 110. In some aspects, the linking message may comprise an incentive to link their social media account to the secure logical storage location.

At step 504, a social media monitoring process may retrieve the social media account identifier stored in the secure logical storage location and retrieve social media data from the social media server 190 associated with the social media account identifier. In some aspects, the social media monitoring process may periodically retrieve (e.g. last day of each month) the social media data for all, or a portion of (including an individual entity), the social media identifier(s) from the secure logical storage locations associated with a plurality of entities. In some aspects, the social media monitoring process may use an application programming interface of the social media server 190 to retrieve social media data from the social media server 190. In some aspects, a social media software agent may execute on the resource server 140 and/or the social media server 190 and may accumulate social media preference data for the entities following the provider's social media account. The social media data may comprise profile data, such as user ID, username, full name, profile picture, biography, location, website, post content, timestamps, location tags, viewing history, and/or hashtags. The social media data may comprise social interaction data, such as comments, likes/reactions, shares, direct messages, message threads, mentions, tags, followers list, followings list, follower count, following count, post engagements, profile visits, and/or story views. In some aspects, the social media monitoring process may not retrieve social media data that the entity has not provided approval to retrieve and/or social media data that is not to be transferred as required by law (e.g. transferring data relating to minors, transfer of data across international borders, transfer of medical information that has been shared on the social media server 190, etc.).

When retrieved, the social media data may be stored in the secure logical storage location associated with the entity at step 506. The social media data may be processed to remove irrelevant data and/or summarize the social media data into one or more account manager processes. The social media data may be processed to remove data that the entity has not provided approval to access and/or data that is not permitted by law to be stored. The social media data may be provided to an AI content generator 910 trained to summarize the social media data into one or more social media preferences. For example, the AI content generator 910 may summarize the social media data into one or more categories, such as a sports fan, a movie fan, a music fan, a book fan, etc. The categories may be further refined into one or more specific categories, such as a hockey fan, or even more specific categories, such as a Toronto Maple Leaf's fan, etc. In some aspects, the social media preferences may be a preference for video content, text content, audio content, and/or image content.

In some instances, the AI content generator 910 may determine one or more media consumption preferences of the entity from the obtained social media data. In some instances, the AI content generator 910 may determine preference from data pertaining to social media accounts that are followed by or following the entity's social media account. For example, the AI content generator 910 may determine that the entity prefers sports content on social media when the social media accounts followed by the entity have a distribution of, for example: 70% family and friends, 11% sports teams and athletes, 6% comedy, 3% cute things, 2% automobiles, and 8% other. The AI content generator 910 may determine these distributions based on a trained statistical model. The AI content generator 910 may categorize social media accounts followed by the entity based on metadata associated with the followed accounts. For example, tags associated with social media posts on the followed accounts may indicate the type of social media account. The AI content generator 910 may determine media consumption preferences of the entity based on social media accounts followed by followers of the entity. For example, the AI content generator 910 may determine that a likelihood that the entity likes sports when a significant portion of the followers of the customer, say 50%, also follow social media accounts associated with sports. In some aspects, the AI content generator 910 may be trained to prohibit use of certain categories, such as adult content, hateful content, illegal content, etc. in the generation of the AI content.

The content generation process 530 may determine when account data changes in the secure logical storage locations associated with the entities at step 508. In some aspects, an account change process may be performed periodically, such as once a month, as a batch process performed on all or a portion of the secure logical storage locations. In some aspects, the account change process may be performed when the account data changes, such as through a data transfer transaction to or from the secure logical storage location.

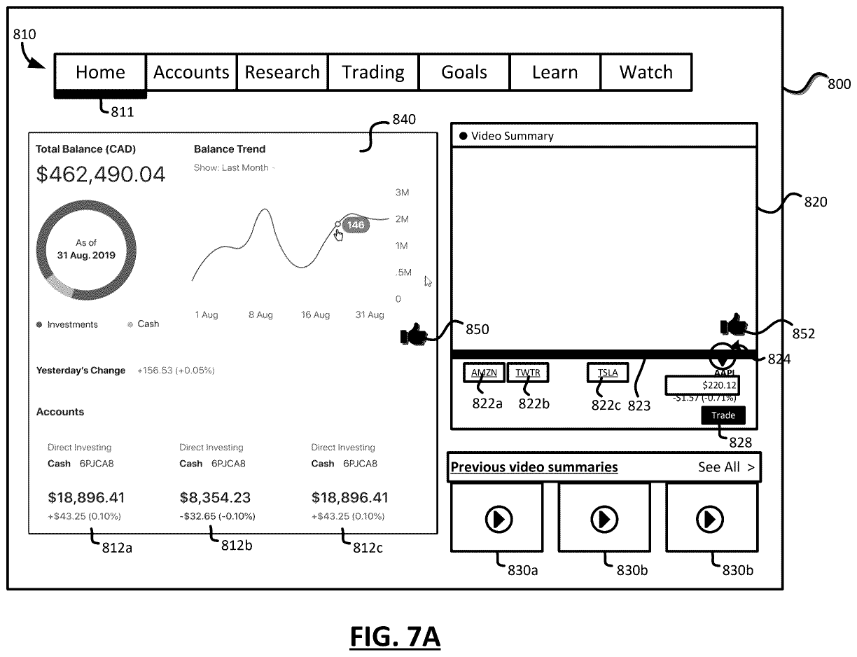

The account data and the social media preferences may be provided to an AI content generator 910 at step 510 and shown in more detail in FIG. 6. In some aspects, a retrieval process executing on the processor 200 of the resource server 140 may determine the secure logical storage location associated with the entity from the protected data resource 150. The retrieval process may transfer at least a portion of the account data and the social media preferences from the secure logical storage location stored on the protected data resource 150 to the resource server 140. The processor 200 may route the account data and/or the social media preferences to the high-bandwidth memory 406 associated with one or more of the GPUs 404 executing the AI content generator 910. In some aspects, the account data may be account data over a discrete period, such as a month. In some aspects, the processor 200 of the resource server 140 may compare the current account data to the previous account data to determine differences between the current account data and the previous account data and may route these differences to the GPU 404 for processing by the AI content generator 910.

In some aspects, a selection process 920 executing on the processor 200 of the resource server 140 may determine a configuration of the AI content generator 910 based at least in part on the social media preferences. The processor 200 may route the account data and/or the social media preferences to the AI content generator 910 that may be previously trained to generating media content corresponding to the social media preferences of the entity. When a suitable configuration for the AI content generator 910 is not currently executing on one of the GPUs 404, the processor 200 may instruct an idle GPU 404 to retrieve a suitable AI content model from the model repository 410 prior to providing the account data and/or the social media preferences to the AI content generator 910.

A configuration of the AI content generator 910 may be selected based on the social media preferences. For example, when the social media preferences specify a preference for text content, the AI content generator 910 may include a Large Language Model (LLM) 912, such as OpenAI's GPT-4, Google's BERT or T5, Microsoft's Turing-NLG, Jasper, Copy. ai, Writesonic, Rytr, etc. In another example, when the social media preferences specify a preference for image content, the AI content generator 910 may include an image generator 914, such as OpenAI's Dall-E, MidJourney, Stable Diffusion, DeepAI's text to image API, Microsoft Designer, Craiyon, etc. In another example, when the social media preferences specify a preference for video content, the AI content generator 910 may include a video generator 916, such as Synthesia, Pictory, Lumen5,InVideo, Kapwing, Runway ML, etc. In yet another example, when the social media preferences specify a preference for audio content, the AI content generator 910 may include an audio generator 918, such as Google DeepMind's WaveNet, ElevenLabs, Amazon Polly, IBM Watson Text to Speech, Microsoft Azure Cognitive Services, Resemble AI, etc. In some aspects, a combination of the different AI content generators 910 may be selected based on the social media preferences. For example, when the social media preferences specify a preference for text content and video content, a pair of AI content generators 910 may be selected, namely an LLM 912 and a video generator 916. Other examples include different combinations.

In some aspects, the AI content generator 910 may comprise a compositor process 922, which may receive the generated content from one or more of the LLM 912, image generator 914, video generator 916, and/or audio generator 918. The compositor process 922 may merge the different types of generated content into a presentation suitable for transmission and display on the account holder device 110.

Although specific LLMs 912, image generators 914, video generators 916, and/or audio generators 918 are mentioned, other aspects may have specially trained AI content generators 910 that may be trained on particular content. In some aspects, the social media preference may specify a type of LLM 912, image generator 914, video generator 916, and/or audio content generator 918. For example, a video generator 916 may be specifically trained on sports content and may be selected when the social media preferences specify that the entity is particularly interested in sports content. For example, Pictory may be particularly suitable for creating sports highlights, summaries, and/or promotional content. In another example, an LLM 912, an image generator 914, a video generator 916, and/or an audio generator 918 may be trained on financial reports, financial audio, and/or financial videos, etc. When the secure logical storage locations include financial data, this financial data may be provided to the specially trained financial AI engine(s) to generate a financial report/presentation based on the account data for the entity.

In some instances, the video generator 916 may be trained based on a particular personality. For example, the video generator 916 may be trained using images, video, and/or audio of a personality from BNN Bloomberg. When the social media preferences for an entity include being a follower of the personality, this particular video generator 916 may be retrieved from the model repository 410 that may be used to generate media content of the account data for the entity. Other aspects may include a different AI engine 910 for each personality. In some aspects, the personalities may receive a royalty for use of their likeness to train the AI content generator 910. In some aspects, the resource server 140 may maintain a count of the number of times each of the particular AI content generator 910 has been provided to account holder devices 110 to determine an amount of the royalty.

In another aspect, one or more compositors 922 may be trained for particular personalities and the compositor 922 may transform a generic generated content from the LLM 912, the image generator 914, the video content generator 916, and/or the audio generator 918 into an individualized generated content based at least on one or more of the social media preferences associated with the entity. In this manner, the processing of the account data for many entities may have improved efficiency as the LLM 912, the image generator 914, the video content generator 916, and/or the audio generator 918 may be the same for all the entities. For example, multiple identical replicas of the LLM 912, the image generator 914, the video content generator 916, and/or the audio generator 918 may be executing on their own GPUs 404 and may be generically trained. These identical replicas may be maintained within the memory 406 for the GPUs 404 and may process account data for many different entities. In this manner, an amount of data transmission from the model repository 410 may be reduced as the only replica to be swapped between entities is the custom compositor 922. The compositor 922 may be the custom AI engine to be loaded onto one of the GPUs 404 to personalize the generic generated content. Privacy and/or security may also be maintained when the customized compositor 922 for each of the entities may be stored in their respective secure logical storage locations rather than the model repository 410. The customized compositor 922 may be trained specifically for each entity and may include personal data.

The processor 200 may initiate a payload conversion process, such as chunking, to convert the account data and/or the social media preference data into chunks 930 that are suitable for the AI content generator 910, such as chunks, a vector, or other encoding. In some aspects, the account data may comprise a balance, a summary of transactions occurring regarding data flow into and out of the secure logical storage locations, and/or one or more projected or expected transactions. The account data may comprise an account modifier applied to amounts in the secure logical storage location. For example, the data flow may be one or more regular, recurring transactions and/or one or more irregular transactions. In some aspects, the incoming transactions may comprise deposits from other secure logical storage locations. Other aspects may comprise a transfer of data from one secure logical storage location to another secure logical storage location. The transactions may comprise a receiver, a transmitter, an amount transferred, and a direction of transfer.

The AI content generator 910 may receive account data and/or the social media preferences data from the protected data resource 150 via the processor 200. The processor 200 may execute a distributing module that may comprise instructions to send, transmit, and/or distribute data related to the secure logical storage location to at least one of the GPUs 404. The distributing module may monitor a workload of the GPUs 404 to select the GPU 404 with available capacity. For example, the GPUs 404 may periodically post workloads to the distributing module (e.g. approximately 15-minute intervals) via an application interface. The distributing module may determine that one of the GPUs 404 has a low workload, or workload below a threshold, and in response, distribute queries to that one of the GPUs 404. In some aspects, the distributing module may cooperate with a priority module to assign to the GPUs 404 a higher or greater priority before lower or lesser priority data transfers.

At step 512, the AI content generator 910 may generate media content based on the account data and/or the social media preferences. In some aspects, the account data and/or the social media preferences may be processed with a chunking process that may break the account data and/or the social media preferences into one or more chunks 930. The chunking process may perform a content-aware chunking by segmenting the account data and/or the social media preferences into one or more chunks 930. In one aspect, the chunking process may detect one or more sets of transactions comprising the receiver, the transmitter, an amount transferred, and a direction of transfer. In some aspects, a more general sentence tokenizer may have one or more contextual rules performing the chunking of the account data and/or the social media preference data. In some aspects, the account data may be chunked separately from the social media preference data.

The chunks 930 may be converted into an embedding, such as tokenizing the transaction by at least one of: the receiver, the transmitter, an amount, and direction of the transfer. In an example, the chunk may be tokenized by splitting the chunks into smaller units referred to as tokens. The tokens may be words, sub-words, and/or characters. The tokenizer may be a word tokenizer, a sub-word tokenizer, a character tokenizer, a sentence tokenizer, a whitespace tokenizer, and/or any custom tokenizer. The word tokenizer may split the chunks into individual words. The sub-word tokenizer may break the chunks 930 into smaller units than words, such as sub-words (e.g. unhappiness may be broken into “un”, “happi”, “ness”) or morphemes (e.g. rebuilding may be broken into “re”, “build”, “-ing”). A morpheme may be a smallest meaningful unit in a language with semantic meaning. A sub-word may not always carry a standalone meaning. In another example, the word “unbelievable” may be broken down using morphemes as “un-”, “believe”, “-able” whereas a Byte Pair Encoding may break the word into sub-words “un”, “bel”, “iev”, “able”. The character tokenizer may split text into individual characters for languages with complex morphology (e.g. Finnish, Turkish, Arabic, Hebrew, Russian, etc.) and/or for fine-grained text analysis. The sentence tokenizer may be similar to the one previously described with reference to chunking. The whitespace tokenizer may split text based on whitespace characters.

When the chunks 930 have been tokenized into tokens, the tokens are then converted into a dense vector of fixed size. The tokens may be provided to an embedding layer that maintains an embedding matrix of size V x D, wherein V is a vocabulary size and D is an embedding dimension for the vector. The embedding matrix contains a vocabulary of unique tokens in an indexed dataset. The embedding layer may map each token to a high-dimensional space whereby positional encodings may be added to the token embeddings. A self-attention process may weigh the token embeddings in relation to others in the sequence enabling the embedding process to focus on relevant parts of the chunks when generating the embeddings. In some aspects, the embedding process may be a feed-forward neural network or a transformer having a number of layers to refine the representations of the embeddings. The tokens may be provided to a previously trained AI content generator 910.

As shown particularly in FIG. 6, the selection process 920 may receive the tokens and/or chunks 930 comprising the social media preference data and/or the account data. The selection process 920 may route the tokens and/or chunks 930 to one or more of the AI models (e.g. the LLM 912, the image generator 914, the video content generator 916, and/or the audio generator 918). In some aspects, the selection process 920 may transform the tokens and/or chunks 930 into a form suitable for the respective AI model. In this aspect, the AI models 912, 914, 916, 918 may generate genericized AI generated content based on the tokens and/or chunks 930 of the account data and/or social media preference data. The compositor 922 may apply a personalization of the genericized AI generated content to customize this content for a particular entity based on the tokens and/or chunks 930 of the social media preference data. In another aspect, the AI models 912, 914, 916, 918 may generate customized content and the compositor 922 merely forms the AI generated content into a format suitable for transmission to the account holder device 110, such as a layout for a website and/or an application executing on the account holder device 110. The compositor 922 may receive a device type from the account holder device 110 and may compose the AI generated content for the particular device type. For example, when the device type is a mobile device, the compositor 922 may provide video content and/or audio content. In another example, when the device type is a large display, the compositor 922 may provide a presentation of video along with text and images.

In some aspects, the AI content generator 910 may generate a video summarizing at least a portion of the account data based at least in part on the social media preference data. For example, when the entity has a social media preference for sports, the AI content generator 910 may, via the selection process 920, select the video generator 916 and generate or provide a prompt to the video generator 916. The prompt may specify as an input, such as the account balance, a recommended savings goal, an avatar, and/or a social media preference, such as sports or a like for cats. For example, the prompt may specify a recommended saving goal in terms of a sports game tickets, particularly for their preferred sports team as provided by the social media preference data. An example prompt may be: “generate an encouraging video of a cat avatar stating the savings last month in terms of the value of a Toronto Raptors'game ticket.” In some aspects, the AI content generator 910 may retrieve external data over the network 120, such as the current price of a Toronto Raptors'game ticket. Other aspects may retrieve other types of external data from an external database 160 based on the social media preference data. In response to the prompt, the video generator 916 may generate video data, e.g. one or more image frames and audio, that may have a cat avatar saying, “last month you saved 15% of a Toronto Raptors game ticket. Keep up the work and you can buy a ticket in 7-months.” Multiple preferences from the social media preference data may be incorporated into the AI generated content. In another example, when the social media preference data also specifies the entity has environmental attitudes, these may influence the prompt. For example, by displaying a green colour in the background of the generated video.

In some aspects, the video generator 916 may generate one or more video segments based on one or more corresponding prompts. The video segments may be collated into a single file or may be separate video files. One or more of the video segments may be provided to the user interface 800 on the account holder device 110 along with one or more corresponding user interface elements for the video segments. The user interface elements may be labels or buttons that include identifying information for the topics corresponding to the video segments. For example, a plurality of buttons/icons which are labeled using symbols (e.g. ticker symbols) associated with the tradeable objects corresponding to the video segments may be generated. The user interface elements are selectable to initiate playback of the respective video segments and/or to advance or reverse the video to particular time points within a single video. That is, a video segment may be played back when the user interface element that corresponds to the video segment is selected.

The user interface elements are displayed on the account holder device 110 concurrently with playback of the video. In particular, the user interface elements are displayed at positions that correspond to their respective playback start timestamps. For example, a playback interface 820 for videos may display a playback control bar. The user interface elements may be displayed at positions along the playback control bar that correspond to the start times of the respective video segments.

In some aspects, the AI content generator 910 may retrieve advertisement data 940 from an external advertisement database 160. The advertisement data 940 may be retrieved based on the social media preference data. The advertisement data 940 may be incorporated into the selection process 920 to generate advertisements relevant and/or consistent with the social media preference data. In some aspects, the advertisements may explicitly be generated to interrupt the AI generated account summary content. In other aspects, the advertisements may be subtly included with the account summary content. For example, when the social media preference data includes a preference for a particular beverage, then the avatar within the AI generated account summary may be drinking that particular beverage and/or may have that beverage present on a desk, such as product placement within a movie. The advertisement data 940 may include products and/or services of the provider of the resource server 140. For example, when the resource server 140 is provided by a financial services provider, the AI generated video may include an advertisement mentioning, “travel with confidence by signing up for TD Travel Insurance and using your TD travel rewards card when you follow the Raptors around the NBA.” In another aspect, the advertisement data 940 may be selected based, in part, on the account data. For example, when the account data indicates a purchase of an airline ticket, the AI generated account summary may provide an advertisement for travel insurance.

In some aspects, the selection process 920 may retrieve seed content data from the media server 180. The seed content data may comprise previously generated prompts, chunks, embeddings, and/or text content, video content, and/or audio content that may provide the AI content generator components 912-922. The seed content data may be used as a starting point for the AI content generator components 912-922. For example, the seed content data for the video generator 916 may comprise clips from a recent sporting game for inclusion in the AI generated video content. After receiving the seed video content data, the selection process 920 may obtain metadata associated with the video. The video metadata may include various types of information regarding the video, such as title, description, duration, size, bitrate/compression, frame rate, display resolution, and tags (or meta tags). The video metadata includes text associated with the video content. In some aspects, the video data may include a separate audio stream and/or closed-captioning text file that is associated with video content stream. An audio stream may, for example, comprise a bitstream containing audio data that corresponds to speech uttered by persons depicted in the video content stream. A closed-captioning text file may include alphanumeric text corresponding to speech uttered by persons depicted in the video content stream.

The video generator 916 may identify one or more video parameters associated with the video based on the metadata. In particular, the video generator 916 may analyze the text (e.g. closed captioning) associated with the video content to determine whether the text matches social media preference data. The video generator 916 may determine one or more segments of the video. A video segment refers a portion of the video content that has a fixed start time and a fixed end time, i.e. a video segment has a fixed duration. In particular, the video segment has a playback start timestamp. The playback start timestamps of one or more video segments may be indicated in the metadata for the video. For example, the metadata may indicate the start timestamps of video segments corresponding to a plurality of different topics which are covered in the video content. The metadata may include, for example, identifiers of one or more topics and the playback start timestamps associated with the topics. The video generator 916 may then determine which of the segments indicated in the metadata correspond to the social media preference data identified within the text associated with the video content.

In another example, the seed content data may comprise an image of a famous painting for the image generator 916. In yet another example, the seed content data may be passages from a book for the LLM 912. In even yet another example, the seed content data may be AI generated content from other entities with similar social media content data.

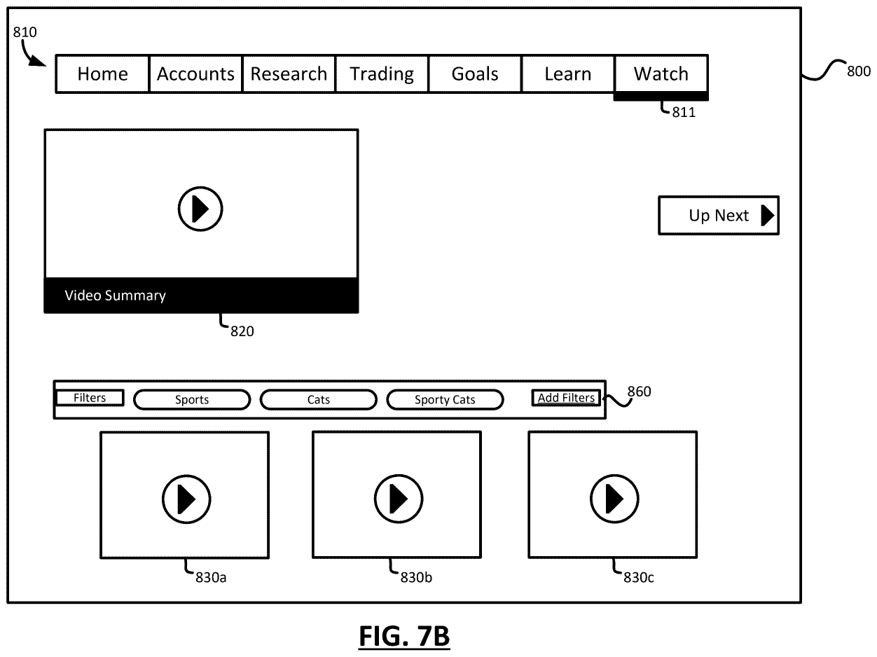

Once the AI generator 910 completes generating the AI generated content, the AI generated content may be stored in the secure logical storage location at step 514. Other aspects may have the AI generated content stored in a media source server 180 specifically optimized to provide multimedia content. In some aspects, the resource server 140 may provide a notification to the account holder device 110, such as a text, email, app notification, etc., that the AI generated content is ready for review. In response, the entity may select the notification, which may require authentication to access their respective secure logical storage location. Once authenticated, the resource server 140 may provide a user interface 800 for a resource management application, such as shown in FIGS. 7A and 7B. The account holder device 110 may execute instructions to present the user interface 800 on a display of the account holder device 110 at step 516. The user interface 800 may allow users to perform various actions relating to management of their resources, such as financial resources (e.g. cash, investments, etc.). The user interface 800 may include a navigation bar 810 and a plurality of user interfaces 811 corresponding to different pages of the user interface 800. A “Home” page of the user interface is shown in FIG. 7A. The “Home” page may provide a summary of a user's financial information, such as total balance, balance trends, and account data for one or more different accounts 812a-812c.

Depending on the type of AI generated content, the resource server 140 may perform one or more adjustments to the user interface 800. For example, when the AI generated content comprises AI generated video and/or audio content, then the resource server 140 may execute instructions to provide a playback interface 820. In another example, when the AI generated content comprises AI generated text and/or images, the resource server 140 may execute instructions to provide an image presentation interface 840. Some aspects have both the playback interface 820 and the image presentation interface 840, such as shown in FIG. 7A. When the AI generated content comprises only AI generated video and/or audio content, the user interface may resemble that shown particularly in FIG. 7B.

This playback interface 820 may play AI generated video content and/or AI generated audio content from the respective secure logical storage location that are available on the resource management application. For example, videos and/or audio that are selected by entities via the user interface 800 may be shown in the playback interface 820. Additionally, or alternatively, videos and/or audio may be selected automatically and begin playing in the playback interface 820 when a user lands on the “Home” (or other) page of the user interface 800. The user interface 800 may also present previous summaries 830a-830c for viewing by a user of the resource management application. As shown in FIG. 7A, the playback interface 820 may include numerous different graphical components. The playback interface 820 may include a progress bar 823 and a progress indicator 824. The progress indicator 824 graphically represents the current position of the playback. Accordingly, the progress indicator 824 moves along the progress bar 823 when the video and/or audio is being played. In some aspects, one or more buttons 822a-822c may be present proximate to the playback interface 820. When selected, the respective button 822a-822c may advance or reverse playback to a specific place within the video and/or audio along with a resulting advance or reverse of the progress indicator 824. The buttons 822a-822c may be labelled by the AI content generator 910.

The user interface 800 may include a plurality of user interface elements in a filter area 860 for allowing entities to select one or more filter criteria. The selected filter criteria may be applied in presenting the videos and/or audio which the entity desires to be presented. For example, the filter criteria may be applied to further narrow the subset of content from previously generated AI content.

The image presentation interface 840 of the user interface 800 may be populated with textual and/or images relating to the account data. In some aspects, the textual and/or images may be generated by a conventional reporting process. In some aspects, one or more of the textual and/or images may be generated by the AI content generator 910.

In some aspects, the user interface 800 may provide a feedback interface to provide feedback from the entity to the AI content generator 910. In the aspect shown in FIG. 7A, a textual/image feedback interface 850 may provide feedback from the entity to the LLM 912 and/or the image generator 914 and a video/audio feedback interface 852 may provide feedback from the entity to the video generator 916 and/or the audio generator 918. In aspects where the AI generator components 912, 914, 916, 918 are generic, the compositor 922 and/or the selection process 920 may receive the feedback for training. The feedback may be used to continually train the AI content generator 910 and/or its respective AI generator components 912, 914, 916, 918, 922. In other aspects, the feedback may be collected and may be used to train the AI content generator 910 and/or its respective AI generator components 912, 914, 916, 918, 922 in a batch training process.

Although the aspects herein describe the AI generated content displayed on the account holder device 110 upon access of their secure logical storage location on the resource server 140, other aspects may provide the AI generated content to the social media server 190 via the social media software agent executing on the social media server 190. The social media software agent may receive the AI generated content along with the social media account identifier from the resource server 140. The social media software agent may transfer the AI generated content to the social media account associated with the social media identifier by tagging the AI generated content with the social media account identifier. In other aspects, the social media software agent may directly transmit the AI generated content via direct message, posting the AI generated content directly to the social media account, and/or some other manner. In some aspects, the social media software agent may set permissions on the AI generated content to only permit access to the AI generated content by the social media account associated with the social media account identifier.

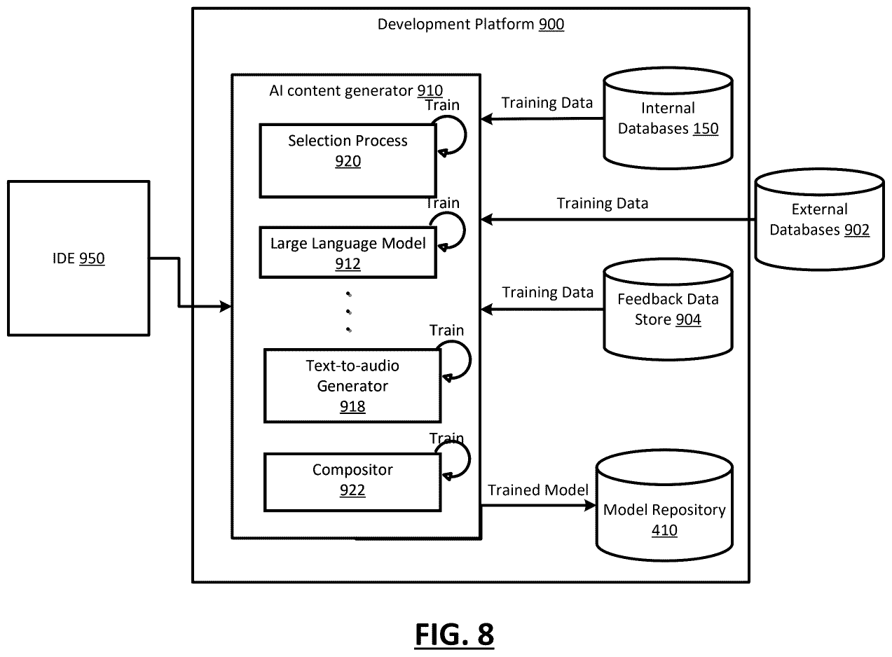

Turning to FIG. 8, an AI development platform 900 is shown for training the AI content generator 910 to generate AI content. An integrated development environment (IDE) 950 may enable a provider to develop, train, and/or retrain the AI content generator 910. The IDE 950 may include a software application 270 with a programming interface accessible by a developer device (not shown), which may be a computing system 105, over the network 120 or via a local connection. The IDE 950 may be a web application that can be accessed at a network address, uniform resource locator (URL), etc. The IDE 950 may be locally or remotely installed on a computing system 105 where the IDE 950 is accessed and used locally.

The IDE 950 may be used to design an AI content generator 910 using the user interface of the IDE 950. For example, the user interface may be output as part of the software application that interacts with the IDE 950. A developer may use an input mechanism to make selections from menus to add pieces to the AI content generator 910, such as data components, model components, analysis components, etc., within a workspace of the user interface. The menus may include a plurality of graphical user interface (GUI) menu options, which can be selected to reveal additional components that can be added to the model design shown in the workspace. The GUI menu options may include options for adding features such as neural networks, machine learning models, AI models, data sources, conversion processes (e.g., vectorization, encoding, etc.), analytics, etc. The developer may continue to add features to the AI content generator 910 and connect the features using edges and/or other means to create a flow within the workspace. For example, the developer may add a node to a flow of a new model within the workspace. For example, the developer may connect a node to another node in the flow via an edge, creating a dependency within the flow. When the developer is done, the IDE 950 can save the model for subsequent training and/or testing.

The training process for training and/or retraining the AI content generator 910 may involve an executable script configured to read data from the data resource 150 and/or the external database 902 and input the data to the AI content generator 910. For example, the executable script may use identifiers (IDs) of one or more data locations (e.g., table IDs, row IDs, column IDs, topic IDs, object IDs, etc.) to identify locations of the training data within the data resource 150 and query an API of the data resource 150. In response, the data resource 150 may receive the query, load the requested data, and return the data to the executable script, where the data is input to the AI content generator 910. The training process may be managed via an interface of the IDE 950, allowing for supervised learning during the training process. In other aspects, the training process may perform unsupervised learning.

In some aspects, the script may iteratively retrieve additional training data sets from the data resource 150 and iteratively input the additional training data sets into the AI content generator 910 during the execution to continue to train the AI content generator 910. The script may continue until instructions within the script direct the script to terminate, which may be based on a number of iterations (e.g. training loops), total time elapsed during the training process, etc.

The IDE 950 may also be used to retrain the AI content generator 910 after being deployed. The training process may use executional results that have been generated or output by the AI content generator components 912, 914, 916, 918, 920, 922 in a live environment for retraining. For example, a scoring AI model (not shown) may score output from the AI content generator components 912, 914, 916, 918, 920, 922 and feedback those scores to retrain the AI content generator components 912, 914, 916, 918, 920, 922 to further enhance accuracy and/or relevancy. The feedback may include indications of whether the generated output scores match scores resulting from a manual evaluation, such as based on the feedback received from the entity. In yet another example, the feedback from the entity may be used to train and/or retrain the AI content generator components 912, 914, 916, 918, 920, 922 to further enhance its accuracy, relevancy, and/or reliability. The feedback data may be captured and stored within a feedback data store 904 or other data store within the live environment and can be subsequently used to retrain the scoring AI model and/or the AI content generator components 912, 914, 916, 918, 920, 922.

Although the description describes LLMs 912, image generators 914, video generators 916, and/or audio generators 918, other generators may be one or more rule-based systems, decision trees, support vector machines (SVM), K-nearest neighbors (KNN), Naïve Bayes, Recurrent Neural Networks (RNN), Convolutional Neural Networks (CNN), Transformers, Graph Neural Networks (GNN), autoencoders, and/or other AI-based content generators.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

A storage medium may be coupled to the processor such that the processor may read information from, and write information to, the storage medium. In the alternative, the storage medium and the processor may share the same die. The processor and the storage medium may reside in an application specific integrated circuit (“ASIC”). In the alternative, the processor and the storage medium may reside as discrete components.

The aspects herein may execute on a cloud computing platform with on-demand availability of computer system resources, including data storage, and computing power, with automated active management. Clouds are often distributed, with data centers in multiple locations for availability and performance. Computing resources on clouds are shared across multiple tenants through virtual computing environments comprising virtual machines, databases, containers, and other resources. A container is an isolated, lightweight software for running an application on the host operating system. Containers are built on top of the host operating system's kernel and contain applications and some lightweight operating system APIs and services. Virtual machines are a software layer which include a complete operating system and kernel. Virtual machines are built on top of a hypervisor emulation layer designed to abstract a host computer's hardware from the operating software environment. Clouds generally offer hosted databases abstracting high-level database management activities.

Although an aspect of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” may be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

Some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. The executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these aspects, it would be apparent to those of skill in the art that modifications, variations, and alternative constructions would be apparent.

While aspects of the present application have been described, it is to be understood that the aspects described are illustrative, and the scope of the application is to be defined solely by the appended claims when considered with a full range of equivalents and modifications (e.g., protocols, hardware devices, software platforms, etc.) thereto.

The various embodiments presented above are merely examples and do not limit the scope of this application. Variations of the innovations described herein will be apparent to persons of ordinary skill in the art, such variations being within the intended scope of the present application. Features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application in its entirety. The subject matter described herein and in the recited claims intends to cover and embrace all suitable changes in technology.

1. A computing system, comprising:
a communications module communicable with a network;
a memory; and
a processor coupled to the communications module and the memory, the processor being configured to:
retrieve social media data via the network from at least one social media account associated with an account holder, the account holder holding an account separate from the at least one social media account;
determine at least one social media preference based on the social media data;
obtain account data associated with the account;
generate a video summarizing at least a portion of the account data based on the at least one social media preference; and
provide the video on an account holder device.

2. The computing system according to claim 1, further comprising the processor being configured to: identify the at least one social media account by searching for an identifier of the account holder in a search engine of at least one social media platform.

3. The computing system according to claim 1, further comprising the processor being configured to: identify the at least one social media account associated with the account holder by linking a first social media account associated with the account holder to an account manager.

4. The computing system according to claim 3, further comprising the processor being configured to: retrieve the social media data related to a plurality of the at least one social media account that are linked to the first social media account associated with the account holder; and determine the at least one social media preference from the plurality of the at least one social media account.

5. The computing system according to claim 4, wherein the at least one social media preference comprises a plurality of categories for the plurality of the at least one social media account.

6. The computing system according to claim 1, wherein the generating the video further comprises: processing a subset of the account data and the at least one social media preference into an artificial intelligence content generator.

7. The computing system according to claim 1, wherein the social media data comprises metadata associated with at least one followed account.

8. The computing system according to claim 7, further comprises the processor being configured to: categorize the at least one followed account into at least one category.

9. The computing system according to claim 1, wherein the at least one social media preference is determined periodically.

10. The computing system according to claim 1, wherein the account data comprises at least one transfer to or from the account.

11. A computer-implemented method comprising:
retrieving social media data via a network from at least one social media account associated with an account holder, the account holder holding an account separate from the at least one social media account;
determining at least one social media preference based on the social media data;
obtaining account data associated with the account;
generating a video summarizing at least a portion of the account data based on the at least one social media preference; and
providing the video on an account holder device.

12. The computer-implemented method according to claim 11, further comprising identifying the at least one social media account associated with the account holder by searching for an identifier of the account holder in a search engine of at least one social media platform.

13. The computer-implemented method according to claim 11, further comprising identifying the at least one social media account associated with the account holder by linking a first social media account associated with the account holder to an account manager.

14. The computer-implemented method according to claim 13, further comprising retrieving the social media data related to a plurality of the at least one social media account that are linked to the first social media account associated with the account holder; and determining the at least one social media preference from the plurality of the at least one social media account.

15. The computer-implemented method according to claim 14, wherein the at least one social media preference comprises a plurality of categories for the plurality of the at least one social media account.

16. The computer-implemented method according to claim 11, wherein the generating the video further comprising: processing a subset of the account data and the at least one social media preference into an artificial intelligence content generator.

17. The computer-implemented method according to claim 11, wherein the social media data comprises metadata associated with at least one followed account.

18. The computer-implemented method according to claim 17, further comprising categorizing the at least one followed account into at least one category.

19. The computer-implemented method according to claim 11, wherein the at least one social media preference is determined periodically.

20. The computer-implemented method according to claim 11, wherein the account data comprises at least one transfer to or from the account.
